(19) United States
(12) Patent Application Publication
(10) Pub. No.: US 2006/0126121 A1
(43) Pub. Date: Jun. 15, 2006

(54) System and method for forming image

(75) Inventor: Woo-Jun Chung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/252,613

(22) Filed: Oct. 19, 2005

(30) Foreign Application Priority Data
Dec. 14, 2004 (KR) 2004-105664

(51) Int. Cl. H04N 1/405

(52) U.S. Cl. 358/3.06

(57) ABSTRACT

A system and a method for forming an image are provided. The method includes the steps of dividing an input image into sub cells including a predetermined number of pixels, calculating gray level values of the sub cells, calculating direction information values of the sub cells;, selecting halftone patterns corresponding to the gray level values and the direction information values from a stored lookup table, and applying the halftone patterns to positions of the sub cells so as to generate and output a binary image for the input image.

### CROSS-REFERENCE TO RELATED APPLICATIONS

This application claims the benefit under 35 U.S.C. § 119(a) of Korean Patent Application No. 2004-105664, filed on Dec. 14, 2004, in the Korean Intellectual Property Office, the entire disclosure of which is hereby incorporated by reference.

### BACKGROUND OF THE INVENTION

1. Field of the Invention

The present invention relates to a system and a method for forming an image. More particularly, the present invention relates to a system and a method for forming an image using a lookup table that includes halftone patterns that consider a growth direction of a dot.

2. Description of the Related Art

In general, binary output apparatuses such as digital printers, copiers, binary output liquid crystal displays (LCDs) or the like substantially transmit various color visions using only two colors, that is, black and white colors. For example, in a case of a black and white digital printer, a black and white image is displayed on a monitor using only black and white colors. The black and white digital printer or a personal computer (PC) requires a series of processes to print the black and white images displayed on the monitor with various types of brightness. In other words, the black and white digital printer or the PC converts the black and white image into a grayscale image that represents a color of each pixel with a grayscale value between “0” and “255,” and converts the grayscale image into a binary image. The image having grayscale values between “0” and “255” is called a grayscale image, and the process of converting the grayscale image into the binary image is called halftoning.

Such halftoning technology typically uses either an error diffusion method, a screening method, or a patterning method. In an error diffusion method, an error occurring in a process of converting a grayscale image into a binary image is distributed to adjacent pixels to minimize the average error in the binary image so as to improve representation of the grayscale image and minimize boundary artifacts. In the screening method, a grayscale image is compared with a matrix with arranged threshold values to generate a binary image. In the patterning method, a grayscale image is converted into a binary image using a lookup table including dot patterns corresponding to grayscale values.

In general, a host device compresses halftoning converted binary image data using a compression method such as the Joint Bi-level Image experts Group (JBIG) format set forth in ITU-T Recommendation T.82, the JBIG2 format set forth in ITU-T Recommendation T.88, the Modified Modified Relative Element Address Designate (MMR) coding scheme, or the like to reduce the transmission amount and increase the transmission speed of the binary image data. The host device then transmits the compressed binary image data to an image forming apparatus. The image forming apparatus decompresses the compressed binary image data to perform printing operations. Since binary image data processed by a conventional binary level halftoning method includes information as to the grayscale level “0” or “1” with respect to each pixel, the binary image data has at least 1-bit image information per each pixel. Thus, in a case where a conventional halftoning method is used, binary image data having at least 1-bit image information must be compressed. In a case where a multilevel halftoning method is used, binary image data having many pieces of image information must be compressed and then transmitted.

Accordingly, there is a continuing need for an improved method for compressing and transmitting image data.

### SUMMARY OF THE INVENTION

An aspect of the present invention is to solve at least the above problems and/or disadvantages and to provide at least the advantages described below. Accordingly, an aspect of the present invention is to provide a system and a method for forming an image by which a data amount of image information to be compressed and transmitted can be reduced and image quality can be improved.

According to an aspect of the present invention, a system for forming an image includes an image divider that divides an input image into sub cells including a predetermined number of pixels, a gray level value calculator that calculates gray level values of the sub cells, a direction information value calculator that calculates direction information values of the sub cells, and a halftoning unit that receives the gray level values and the direction information values, selects stored halftone patterns corresponding to the gray level values and the direction information values, and applies the halftone patterns to positions of the sub cells so as to generate and output a binary image for the input image.

The system may further include a storage that stores a lookup table including the halftone patterns corresponding to the gray level values and the direction information values.

The gray level value calculator may include an average grayscale value calculator that calculates average grayscale values of pixels constituting the sub cells, and a quantizer that converts the average grayscale values into the gray level values corresponding to gray levels of the halftone patterns.

The system may further include a printing unit that performs a printing operation with respect to the binary image output from the halftoning unit.

The system may further include a compression and transmission unit that compresses and transmits data including the gray level values and the direction information values of the sub cells calculated by the gray level value calculator and the direction information value calculator, and a decompressor that decompresses the compressed data and provides the decompressed data to the halftoning unit.

The gray level values may correspond to the gray levels of the halftone patterns, and the direction information values may correspond to dot growing directions of the halftone patterns.

The direction information values may be determined by comparing grayscale values of pixels positioned at corners of the sub cells using a predetermined method.

In the predetermined method, if a difference between the greatest and smallest values of the grayscale values of the pixels positioned at the corners of the sub cells is less than a predetermined threshold value, values corresponding to central positions of the sub cells may be determined as the direction information values, and if the difference is more than or equal to the predetermined threshold value, values corresponding to positions of pixels of the pixels having the greatest values at the corners of the sub cells may be determined as the direction information values.

In the predetermined method, if there is no pixel of the pixels having the greatest value at the corners of the sub cells, values corresponding to central positions of the sub cells may be determined as the direction information values.

The halftone patterns may be designed so that dot growing directions are different with respect to the direction information values depending on increases in the gray levels.

According to another aspect of the present invention, a method of forming an image includes the steps of dividing an input image into sub cells including a predetermined number of pixels, calculating gray level values of the sub cells, calculating direction information values of the sub cells, selecting halftone patterns corresponding to the gray level values and the direction information values from a stored lookup table, and applying the halftone patterns to positions of the sub cells so as to generate and output a binary image for the input image.

The calculation of the gray level values may include the steps of calculating average grayscale values of pixels constituting the sub cells, and converting the average grayscale values into the gray level values corresponding to gray levels of the halftone patterns.

The method may further include the step of performing a printing operation with respect to the binary image.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a block diagram of a system for forming an image according to an exemplary embodiment of the present invention;

FIG. 2 is a flowchart of a method of forming an image according to an exemplary embodiment of the present invention;

FIG. 3 is a view illustrating an input image including L×M pixels, the input image being divided into sub cells by an image divider 110 so as to include n×n pixels;

FIG. 4 is a view illustrating one of the sub cells into which the input image of FIG. 2 is divided, the sub cell including 4×4 pixels; and

FIGS. 5A through 5E are views illustrating halftone patterns having different dot growing directions with respect to direction information values.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

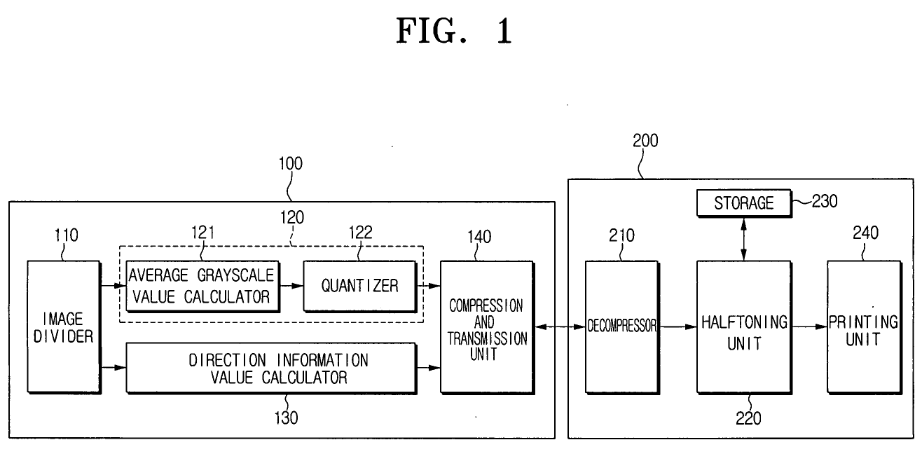

FIG. 1 is a block diagram of a system for forming an image according to an exemplary embodiment of the present invention. Referring to FIG. 1, the system includes a host device 100 and an image forming apparatus 200. The host device 100 includes an image divider 110, a gray level value calculator 120, a direction information value calculator 130, and a compression and transmission unit 140. The gray level value calculator 120 includes an average grayscale value calculator 121 and a quantizer 122. The image forming apparatus 200 includes a decompressor 210, a halftoning unit 220, a storage 230, and a printing unit 240.

When the image divider 110 receives an input image from an external source or an application program unit (not shown) of the host device 100, the image divider 110 divides the input image into sub cells including a predetermined number of pixels and provides the sub cells to the gray level value calculator 120 and the direction information value calculator 130.

The gray level value calculator 120 calculates gray level values of the sub cells input from the image divider 110 and provides the gray level values to the compression and transmission unit 140. The gray level value calculator 120 includes the average grayscale value calculator 121 and the quantizer 122, which will be described in further detail later. Here, the gray level values are calculated from the average grayscale values of pixels constituting the sub cells and related to gray levels of halftone patterns that will be described in further detail later.

The direction information value calculator 130 calculates direction information values of the sub cells input from the image divider 110 and provides the direction information values to the compression and transmission unit 140. Here, the direction information values of the sub cells are calculated by comparing the grayscale values of pixels positioned at corners of corresponding sub cells using a predetermined method and related to dot growing directions of the halftone patterns that will be described later. Here, dots are referred to as areas of halftone patterns represented with a black color. A method of calculating the direction information values will be described in further detail later.

The compression and transmission unit 140 compresses data including the gray level values and the direction information values of the sub cells calculated by the gray level value calculator 120 and the direction information value calculator 130 using any suitable compression method (such as JBIG, JBIG2, MMR, or the like) and transmits the compressed data to the image forming apparatus 200. The decompressor 210 decompresses the compressed data transmitted from the host device 100 and provides the decompressed data to the halftoning unit 220.

The halftoning unit 220 selects halftone patterns corresponding to the gray level values and the direction information values calculated by the gray level value calculator 120 and the direction information value calculator 130 from a lookup table and applies the halftone patterns to positions of corresponding sub cells so as to generate and output a binary image for the input image.

The storage 230 stores the lookup table including the halftone patterns corresponding to the gray level values and the direction information values. Here, the halftone patterns are designed so that dot growing directions are different with respect to the direction information values depending on an increase in a gray level.

The printing unit 240 performs a printing operation with respect to the binary image output from the halftoning unit 220.

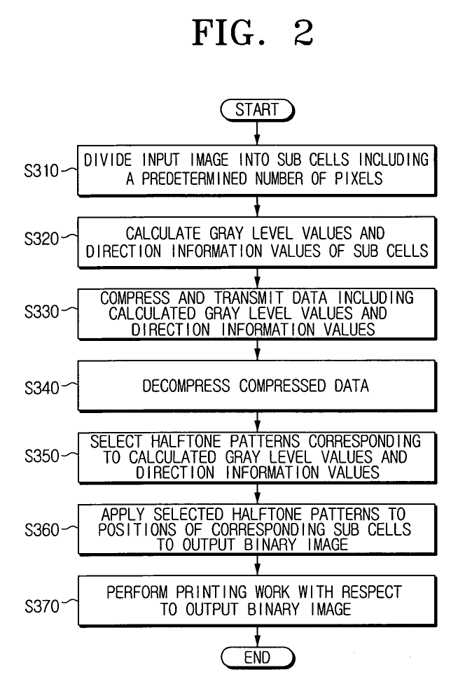

FIG. 2 is a flowchart of a method of forming an image according to an exemplary embodiment of the present invention.

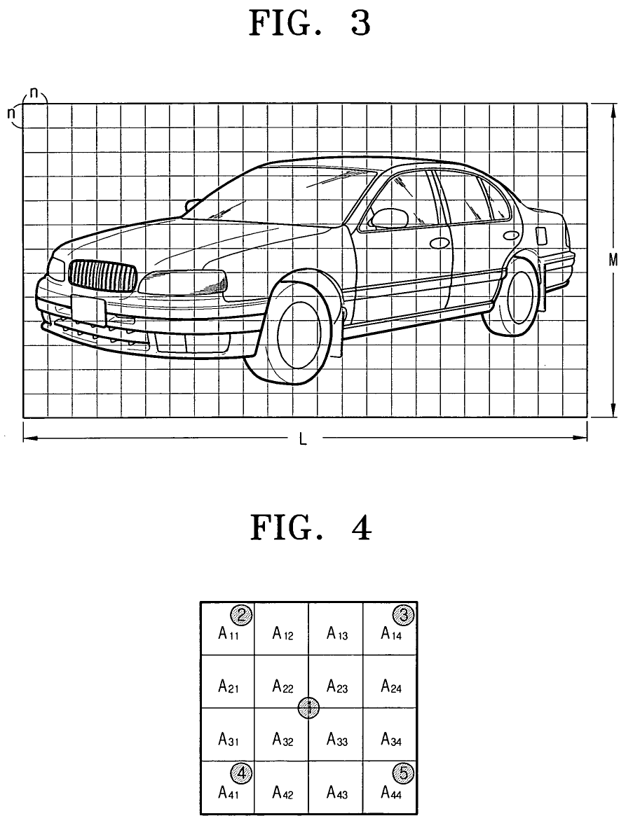

In the present exemplary embodiment, an input image including L×M pixels is divided into sub cells including n×n pixels and then halftone processed. FIG. 3 is a view illustrating an input image including L×M pixels, the input image being divided into sub cells including n×n pixels using the image divider 110 shown in FIG. 1. Here, L denotes a number of pixels in a horizontal direction of the input image, and M denotes a number of pixels in a vertical direction of the input image.

Referring to FIGS. 1 through 3, in operation S310, the image divider 110 receives an input image including L×M pixels, divides the input image into sub cells including n×n pixels, and provides the sub cells to the gray level value calculator 120 and the direction information value calculator 130. An input image shown in FIG. 3 is divided into (L/n)×(M/n) sub cells using the image divider 110.

In operation S320, the gray level value calculator 120 and the direction information value calculator 130 respectively calculate gray level values and direction information values of the (L/n)×(M/n) sub cells input from the image divider 110 and provide the gray level values and the direction information values to the compression and transmission unit 140. This will now be described in detail.

Describing the calculation of the gray level values, the average grayscale value calculator 121 calculates the average grayscale values of the (L/n)×(M/n) sub cells input from the image divider 110 and provides the average grayscale values to the quantizer 122. Here, the average grayscale values are average values of grayscale values of pixels belonging to corresponding sub cells.

The quantizer 122 converts the average grayscale values calculated by the average grayscale value calculator 121 into gray level values corresponding to gray levels of halftone patterns stored in the storage 230 of the image forming apparatus 200 and outputs the gray level values. For example, if the halftone patterns stored in the lookup table are divided into 64 levels from the brightest gray level “0” to the darkest gray level “63”, the quantizer 120 converts the average grayscale values into corresponding gray level values between the gray levels “0” and “63” and outputs the corresponding gray level values. In other words, if an average grayscale value “128” corresponds to a gray level “31” of a halftone pattern, the quantizer 120 outputs the gray level “31” as a gray level value of a corresponding sub cell.

Describing the calculation of the direction information values, the direction information value calculator 130 calculates the direction information values of the (L/n)×(M/n) sub cells input from the image divider 110 and provides the direction information values to the compression and transmission unit 140. Here, the direction information values of the (L/n)×(M/n) sub cells are calculated by comparing grayscale values of pixels positioned at corners of corresponding sub cells using a predetermined method and related to the dot growing directions of the halftone patterns that will be described later.

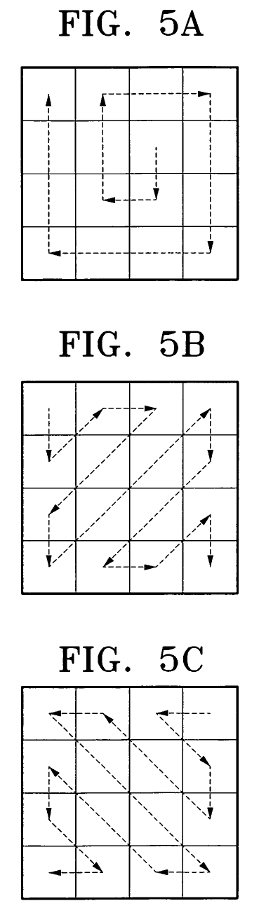

For convenience, a sub cell including 4×4 pixels is taken as an example to explain the calculation of direction information values. FIG. 4 is a view illustrating a sub cell including 4×4 pixels, the sub cell being divided from the input image shown in FIG. 2. Here, Aᵢⱼ denotes a grayscale value of a pixel in an i^{th} row and a j^{th} column of the sub cell, and \textcircled{1} in the center of the sub cell and\textcircled{2}, \textcircled{3}, \textcircled{4}, and \textcircled{5} at corners of the sub cell denote direction information values corresponding to corresponding positions.

The direction information value calculator 130 obtains a difference between the greatest and smallest values of grayscale values A₁₁, A₁₄, A₄₁, and A₄₄ of pixels positioned at the corners of the sub cell and compares the difference with a predetermined threshold value. If the difference is less than the predetermined threshold value, a value “1” corresponding to a central position of the sub cell is determined as a direction information value. If the difference is more than or equal to the predetermined threshold value, a value corresponding to a pixel of pixels having the greatest grayscale value at the corners of the sub cell is determined as the direction information value. For example, if the grayscale value A₁₁ is the greatest, the direction information value is determined as “2.” If the grayscale value A₁₄ is the greatest, the direction information value is determined as “3.” If the grayscale value A₄₁ is the greatest, the direction information value is determined as “4.” If the grayscale value A₄₄ is the greatest, the direction information value is determined as “5.” If there is no pixel having the greatest grayscale value, the value “1” corresponding to the central position of the sub cell is determined as the direction information value.

This particular method of calculating direction information values is only one example of a suitable method. A method of calculating the direction information values may vary depending on the grayscale representation capability of an image forming apparatus and the characteristics of an image to be printed.

In operation S330, the compression and transmission unit 140 receives data including the gray level values and the direction information values of the (L/n)×(M/n) sub cells of the input image calculated by the gray level value calculator 120 and the direction information value calculator 130, compresses the data using any suitable compression method (such as JBIG, JBIG2, MMR, or the like), and transmits the compressed data to the image forming apparatus 200. As described above, in the present exemplary embodiment in which the gray level value is divided into 64 levels, and the direction information value is “1,” “2,” “3,”, “4,” or “5,” the compression and transmission unit 140 compresses data including a 6-bit gray level value and a 3-bit direction information value in each sub cell including 4×4 pixels and transmits the compressed data to the image forming apparatus 200. In other words, the compression and transmission unit 140 compresses and transmits 9-bit/16-pixel (=0.5625 bit/pixel) data for each pixel of the input image. Thus, compared to a conventional method by which at least 1-bit data must be compressed and transmitted for each pixel, the amount of data transmitted can be considerably reduced.

In operation S340, the decompressor 210 decompresses the data including the gray level values and the direction information values, the data being compressed and transmitted by the host device 100, and provides the decompressed data to the halftoning unit 220.

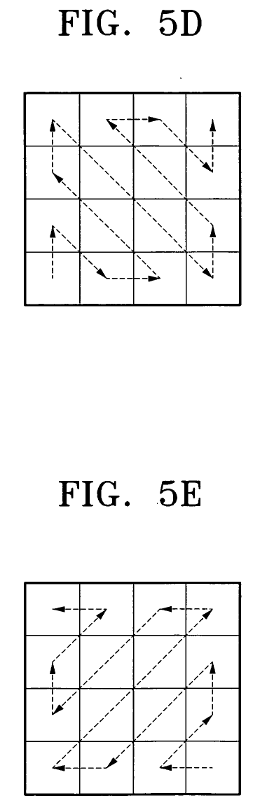

In operation S350, the halftoning unit 220 receives the data including the gray level values and the direction information values of the (L/n)×(M/n) sub cells of the input image from the decompressor 210 and obtains halftone patterns corresponding to the gray level values and the direction information values of the (L/n)×(M/n) sub cells with reference to the lookup table stored in the storage 230. Here, the halftone patterns are designed so that dot growing directions are different with respect to the direction information values and stored as the lookup table in the storage 230 in advance. The halftone patterns will now be described in detail with reference to FIGS. 5A through 5E.

FIGS. 5A through 5E are views illustrating halftone patterns having different dot growing directions with respect to direction information values. FIG. 5A shows a dot growing direction when a direction information value is a value corresponding to a central position of a sub cell. FIG. 5B shows a dot growing direction when the direction information value is a value corresponding to a position in a first row and a first column. FIG. 5C shows a dot growing direction when the direction information value is a value corresponding to a position in the first row and a fourth column. FIG. 5D shows a dot growing direction when the direction information value is a value corresponding to a position in a fourth row and a first column. FIG. 5E shows a dot growing direction when the direction information value is a value corresponding to a position in the fourth row and a fourth column. Here, as dots are grown along directions indicated by arrows, darker gray levels are produced.

As shown in FIG. 5A, a dot is grown from a pixel in a second row and a third column of a sub cell toward a spiral direction. It should be understood that the growth of the dot is not limited to this particular example. The dot may be grown from a predetermined pixel of pixels in the second row and a second column, a third row and the second column, and a third row and a third column toward the spiral direction. If the sub cell includes 5×5 pixels, the dot may be grown from a pixel in the center of the sub cell. Similarly, the growth directions of the dots marked with zigzagged dotted lines as shown in FIGS. 5B through 5E are not limited to the particular examples shown there. The dots may be grown from a pixel corresponding to a direction information value to represent a gray level becoming darker. The image forming apparatus may use full size dots which are the same size as one pixel unit. Alternatively, variable size dots may be used to produce additional gray levels. The choice may vary depending on the capability of the image forming apparatus 200.

In operation S360, the halftoning unit 220 selects the halftone patterns corresponding to the gray level values and the direction information values calculated by the gray level value calculator 120 and the direction information value calculator 130 from the lookup table, and applies the halftone patterns to positions of corresponding sub cells so as to generate and output a binary image for the input image.

In operation S370, the printing unit 240 performs a printing operation with respect to the binary image output from the halftoning unit 220.

In the present exemplary embodiment, the host device 100 includes the image divider 110, the gray level value calculator 120, and the direction information value calculator 130. However, the present exemplary embodiment is not necessarily limited to this. The image forming apparatus 200 may include the image divider 110, the gray level value calculator 120, and the direction information value calculator 130. In this case, the compression and transmission unit 140 and the decompressor 210 shown in FIG. 1 are not necessarily included.

As described above, in a system and a method for forming an image according to the present invention, halftoning can be performed in the unit of a sub cell that includes a predetermined number of pixels. Thus, compared to a conventional method by which halftoning is performed in the unit of pixel, the amount of image information data to be compressed and transmitted from a host device to an image forming apparatus can be considerably reduced.

Also, halftone patterns having dot growing directions that vary with the distribution of gray level values can be applied to sub cells having the same gray level. Thus, compared to the conventional halftoning method, an improved quality image can be formed.

While the invention has been shown and described with reference to certain embodiments thereof, it will be understood by those skilled in the art that various changes in form and details may be made therein without departing from the spirit and scope of the invention as defined by the appended claims.

What is claimed is:

1. A system for forming an image, comprising:
an image divider that divides an input image into sub cells comprising a predetermined number of pixels;
a gray level value calculator that calculates gray level values of the sub cells;
a direction information value calculator that calculates direction information values of the sub cells; and
a halftoning unit that receives the gray level values and the direction information values, selects stored halftone patterns corresponding to the gray level values and the direction information values, and applies the halftone patterns to positions of the sub cells so as to generate and output a binary image for the input image.

2. The system of claim 1, further comprising:
a storage that stores a lookup table comprising the halftone patterns corresponding to the gray level values and the direction information values.

3. The system of claim 1, wherein the gray level value calculator comprises:
an average grayscale value calculator that calculates average grayscale values of pixels constituting the sub cells; and
a quantizer converting the average grayscale values into the gray level values corresponding to gray levels of the halftone patterns.

4. The system of claim 1, further comprising:
a printing unit that performs a printing operation with respect to the binary image output from the halftoning unit.

5. The system of claim 1, further comprising:
a compression and transmission unit that compresses and transmits data comprising the gray level values and the direction information values of the sub cells calculated by the gray level value calculator and the direction information value calculator; and
a decompressor that decompresses the compressed data and provides the decompressed data to the halftoning unit.

6. The system of claim 1, wherein
the gray level values correspond to the gray levels of the halftone patterns, and the direction information values correspond to dot growing directions of the halftone patterns.

7. The system of claim 1, wherein
the direction information values are determined by comparing grayscale values of pixels positioned at corners of the sub cells using a predetermined method.

8. The system of claim 7, wherein
in the predetermined method, if a difference between the greatest and smallest values of the grayscale values of the pixels positioned at the corners of the sub cells is less than a predetermined threshold value, values corresponding to central positions of the sub cells are determined as the direction information values, and if the difference is more than or equal to the predetermined threshold value, values corresponding to positions of pixels of the pixels having the greatest values at the corners of the sub cells are determined as the direction information values.

9. The system of claim 8, wherein
in the predetermined method, if there is no pixel of the pixels having the greatest value at the corners of the sub cells, values corresponding to central positions of the sub cells are determined as the direction information values.

10. The system of claim 6, wherein
the halftone patterns are designed so that dot growing directions are different with respect to the direction information values depending on increases in the gray levels.

11. The system of claim 1, wherein
the direction information values are determined by comparing grayscale values of pixels of the sub cells using a predetermined method.

12. A method of forming an image, comprising the steps of:
dividing an input image into sub cells comprising a predetermined number of pixels;
calculating gray level values of the sub cells;
calculating direction information values of the sub cells;
selecting halftone patterns corresponding to the gray level values and the direction information values from a stored lookup table; and
applying the halftone patterns to positions of the sub cells so as to generate and output a binary image for the input image.

13. The method of claim 12, wherein the step of calculating gray level values comprises the steps of:
calculating average grayscale values of pixels constituting the sub cells; and
converting the average grayscale values into the gray level values corresponding to gray levels of the halftone patterns.

14. The method of claim 12, further comprising:
performing a printing operation with respect to the binary image.

15. The method of claim 12, wherein
the gray level values correspond to the gray levels of the halftone patterns, and the direction information values correspond to dot growing directions of the halftone patterns.

16. The method of claim 12, wherein
the direction information values are determined by comparing grayscale values of pixels positioned at corners of the sub cells using a predetermined method.

17. The method of claim 16, wherein
in the predetermined method, if a difference between the greatest and smallest values of the grayscale values of the pixels positioned at the corners of the sub cells is less than a predetermined threshold value, values corresponding to central positions of the sub cells are determined as the direction information values, and if the difference is more than or equal to the predetermined threshold value, values corresponding to positions of pixels of the pixels having the greatest values at the corners of the sub cells are determined as the direction information values.

18. The method of claim 17, wherein
in the predetermined method, if there is no pixel of the pixels having the greatest value at the corners of the sub cells, values corresponding to central positions of the sub cells are determined as the direction information values.

19. The method of claim 16, wherein
the halftone patterns are designed so that dot growing directions are different with respect to the direction information values depending on increases in the gray levels.

20. The method of claim 12, wherein
the direction information values are determined by comparing grayscale values of pixels of the sub cells using a predetermined method.

21. A computer-readable recording medium having a set of instructions stored therein which, when executed by a computer, causes the computer form an image by performing the steps of:
dividing an input image into sub cells comprising a predetermined number of pixels;
calculating gray level values of the sub cells;
calculating direction information values of the sub cells;
selecting halftone patterns corresponding to the gray level values and the direction information values from a stored lookup table; and
applying the halftone patterns to positions of the sub cells so as to generate and output a binary image for the input image.

22. The computer readable recording medium of claim 21, wherein the step of calculating gray level values comprises the steps of:
calculating average grayscale values of pixels constituting the sub cells; and
converting the average grayscale values into the gray level values corresponding to gray levels of the halftone patterns.

23. The computer readable recording medium of claim 21, further comprising instructions for performing the step of:
performing a printing operation with respect to the binary image.

24. The computer readable recording medium of claim 21, wherein
the gray level values correspond to the gray levels of the halftone patterns, and the direction information values correspond to dot growing directions of the halftone patterns.

25. The computer readable recording medium of claim 21, wherein
the direction information values are determined by comparing grayscale values of pixels positioned at corners of the sub cells using a predetermined method.

26. The computer readable recording medium of claim 25, wherein
in the predetermined method, if a difference between the greatest and smallest values of the grayscale values of the pixels positioned at the corners of the sub cells is less than a predetermined threshold value, values corresponding to central positions of the sub cells are determined as the direction information values, and if the difference is more than or equal to the predetermined threshold value, values corresponding to positions of pixels of the pixels having the greatest values at the corners of the sub cells are determined as the direction information values.

27. The computer readable recording medium of claim 26, wherein
in the predetermined method, if there is no pixel of the pixels having the greatest value at the corners of the sub cells, values corresponding to central positions of the sub cells are determined as the direction information values.

28. The computer readable recording medium of claim 25, wherein
the halftone patterns are designed so that dot growing directions are different with respect to the direction information values depending on increases in the gray levels.

29. The computer readable recording medium of claim 21, wherein
the direction information values are determined by comparing grayscale values of pixels of the sub cells using a predetermined method.
